(19) United States
(12) Patent Application Publication
(10) Pub. No.: US 2026/0014642 A1
(43) Pub. Date: Jan. 15, 2026

(54) DEPTH CONTROL OF FRICTION STIR WELDING

(71) Applicant: Bond Technologies, Inc., Elkhart, IN (US)

(72) Inventors: Arnold David Wright, Edwardsburg, MI (US); John Andrew Bosker, South Bend, IN (US)

(73) Assignee: Bond Technologies, Inc., Elkhart, IN (US)

(21) Appl. No.: 19/268,103

(22) Filed: Jul. 14, 2025

Related U.S. Application Data
(60) Provisional application No. 63/670,161, filed on Jul. 12, 2024.

(51) Int. Cl. B23K 20/12

(52) U.S. Cl. CPC B23K 20/123

(57) ABSTRACT

A process is provided for controlling a friction stir welding process using one of two methods where standard depth/force control is inadequate. Both methods use sensors that are combined and compared to generate forge force, cross-seam force, and traverse forces. Cross-seam force is force perpendicular to the direction of travel and traverse force is aligned with the direction of travel. Forge force is the force applied in the depth direction. The first method uses only cross-seam force and the second method uses cross-seam force combined with traverse force as an input into a control loop that sets the tool depth command. The first method also uses spindle power to control the speed of the spindle. Both methods use forge force only as a safety limit. The control loop maintains forge depth better than forge force, temperature, or spindle power.

### CROSS REFERENCE TO RELATED APPLICATIONS

This application claims the benefit of Provisional Application Ser. No. 63/670,161, filed Jul. 12, 2024, the disclosure of which is incorporated by reference.

### FEDERALLY SPONSORED RESEARCH AND DEVELOPMENT

No federal funds were used for the development of this invention.

### BACKGROUND OF THE INVENTION

The present disclosure relates to friction stir welding, a process that uses a rotating tool generating frictional heat to soften metal below the melting point in order to join materials together. Since the process requires control between the point where a material is solid, and the point where it is liquid, various methods have been developed for controlling the process over the years. While it is possible to simply control the vertical position of the welding tool, with regard to the workpiece, this method has seen little use other than with very small parts.

Most commonly, axial force control is used to manage tool depth in order to achieve successful weld results. In axial force control applications, the traverse rate of the tool is kept constant, and the rpm of the spindle is kept constant. Axial force is used as feedback to manage the tool engagement in the workpiece. Axial force typically increases as the tool penetrates deeper into the workpiece. The reason for this has a lot to do with the geometry of the welding tool. A typical welding tool has a probe that is often tapered on the end and a shoulder which is much wider. The purpose of the shoulder is providing a boundary to contain or redirect the plasticized material to the welding region. When the shoulder engages with the workpiece, the amount of heat generated increases significantly. Normally the resistance to force produced by the shoulder sends a signal to the control system that the tool is too deep reducing the depth of the tool typically reduces the force in the axial direction. This control algorithm is quite common for friction stir welding.

However, in certain applications, the axial force does not increase as the tool descends. The reason for this can be due to a loss of containment of the material (within the desired welding volume), or excessive heating which causes the flow stress of the material to reduce. Loss of containment is where the material escapes the controlled area. A lack of stiffness in the part, the machine structure, or the machine tooling can also cause the relationship between plunge depth and axial force to become nonlinear and even unstable at times.

As the welding tool rotates and travels through the material, softening it with frictional heat, forces are produced along the direction of travel and transverse (or orthogonal) to the direction of travel. For clarity, the orthogonal forces are also known as cross-seam forces. Other methods of controlling the process include using temperature feedback to adjust certain welding parameters.

Some friction stir welding applications (such as long hollow extrusions) require simultaneous dual sided welding. In dual sided welding, two independently controlled (but simultaneously positioned) opposing welding heads simultaneously pass over opposite sides of the same seam. The opposing welding heads remain in alignment with each other as they move relative to the workpiece. In dual sided welding applications where it is not possible to achieve suitable material stiffness, crosstalk between axial/forge force signals from the lower and upper heads can result in difficulty controlling the process with traditional force control.

Position control does not always result in the same result for each weld, so some method of active control is needed to maintain the proper tool engagement with the part. Forge/axial force control alone did not produce repeatable results with all part geometry or geometries (such as a flexible part or insufficient part thickness adjacent the welding area)-a lower axial force could cause the tool to ride either too high or too low, and a higher axial force would result in the tool riding way too low. If the tool is moved too deep into the workpiece, the weld could start to “blow out” into the interior channels of the part, resulting in reduced axial force. A graph representing this relationship is shown in FIG. 6, where the vertical line is the ideal tool engagement, and the plotted line is the tool force. Some parts are also flexible enough that the part could deflect/move as well as the tool. Therefore, if the axial force decreased, there was no way to tell if the lowered force was because the part was moving up/down (due to part flexibility) or the tool was moving up/down (due to machine flexibility). This would normally be fine, but because of the “plunge slightly too deep and axial force is too low” potential where material escapes the weld zone, there was not enough room to stay on one side of the curve and thus control would be unstable.

For certain applications where force control does not produce a useful relationship to depth of the tool, a better method of controlling the welding tool engagement is needed.

### SUMMARY OF THE INVENTION

The present disclosure describes the use of cross-seam force in order to manage the depth of the tool in the workpiece. When the tool is shallow in the workpiece, there is less heat produced. When less heat is produced, the cross-seam force is high. When the tool is deep into the workpiece, a higher amount of heat is produced because there is more tool engaged. Therefore, when the tool is deep into the workpiece, the cross-seam force tends to be low. The reason for this is that a high amount of power produces more heat which causes the material to soften, and softer material then requires less torque to stir. Cross-seam control alone is only stable within a certain range of weld temperatures, so the use of power control or traverse force feedback may also be implemented to control the welding process over a larger range of weld temperatures.

While these forces vary as process and conditions change, these “in-plane” forces give information about the process this invention uses in-plane forces as a controlling variable to maintain a good successful welding process. In addition to the use of cross-seam force, it has been shown to be beneficial to use power control. Power is the product of spindle torque and spindle RPM. By measuring the spindle torque and comparing that to a targeted power set point, an error signal can be sent to the motor drive. The drive then adjusts the torque to achieve the target. It does so by raising or lowering the current that is sent to the spindle motor, which in turn causes the motor to speed up or slow down, thereby regulating power. Therefore, in some cases it is useful to maintain constant power and adjust the cross-seam force using the aforementioned control algorithm.

Furthermore, it can be helpful to use force control set in such a way as to provide a boundary to avoid runaway conditions. In the event that the force in the axial direction becomes extremely high or extremely low, a force control algorithm can be helpful to maintain control of the process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an isometric view of a friction stir welding machine and welded joint;

FIG. 2 is a graphical representation of the forces and movement of the welding spindle;

FIG. 3 is a group of charts showing measured forces for a typical weld based on tool depth;

FIG. 4 is a flow chart/diagram of a first control method;

FIG. 5 is a flow chart/diagram of a second control method;

FIG. 6 shows a graph of forge force vs. tool engagement;

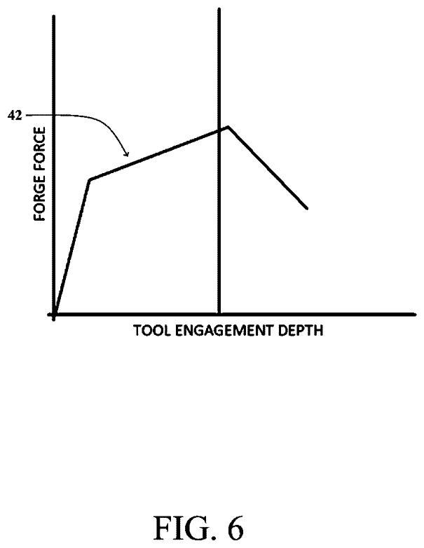

FIG. 7 shows a properly welded joint with a graph of force, depth, and temperature;

FIG. 8 shows an improperly welded joint from insufficient depth;

FIG. 9 shows an improperly welded joint from excessive depth;

FIG. 10 shows a 1 meter long weld implementing the second control method;

FIG. 11 shows a weld implementing the second control method where the top surface was intentionally made irregular; and

FIG. 12 is a geometric diagram of the force sensors and measurements for calculating force.

### DESCRIPTION OF THE PREFERRED EMBODIMENT

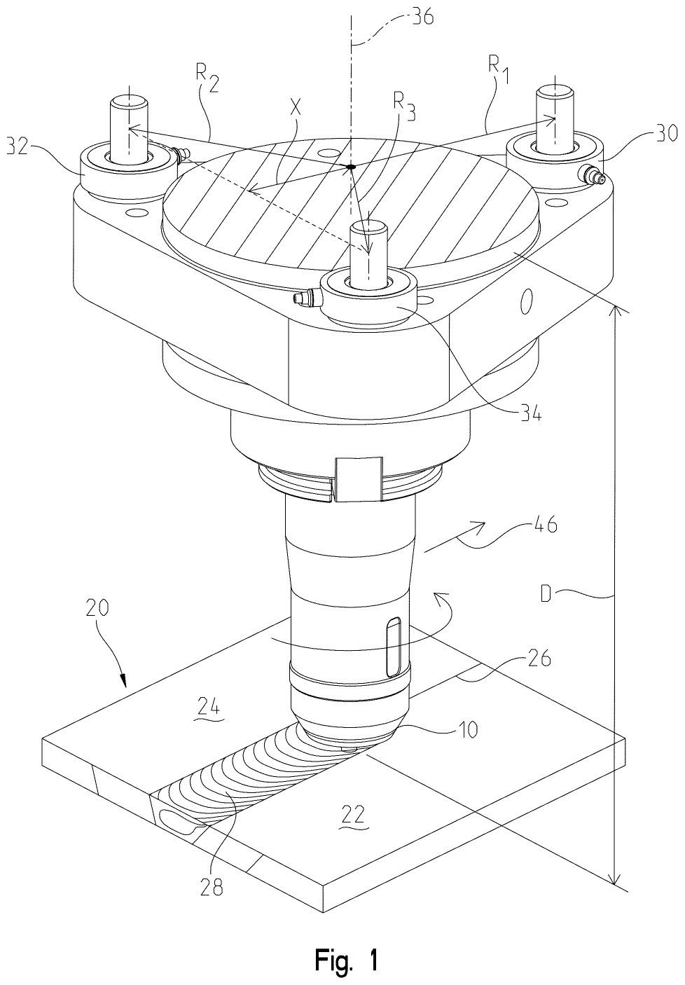

A friction stir welding head 10 engages with a workpiece 20, as shown in FIG. 1. Friction stir welding is performed by the head 10 with a pin and a shoulder that rotate. The pin enters the workpiece 20 with the shoulder in contact with the surface of the workpiece 20 and then travels along a seam to join the two parts. The workpiece 20 typically consists of a first side 22 that abuts a second side 24 that meet at a joint line 26. After the welding head 10 rotates and passes over the joint line 26, a weld 28 joins the first and second sides 22, 24. This process of friction stir welding includes certain forces to form the weld 28. These forces include forge force 42, which is the force from the tool entering the workpiece. The forge force 42 is coaxial with the rotational/spindle axis of the tool which is typically perpendicular to the surface of the workpiece. Traverse force 40 is the force that is in the direction of travel. Cross-seam force 44 is perpendicular to the direction of travel and is created from the tool rotation and travel of the tool in the travel direction 46. The cross-seam force in friction stir welding is dependent on the tool rotation. If the tool is rotating clockwise, then the cross-seam force 44 generally forces the tool to the left relative to the direction of travel. If the tool is rotating counter-clockwise, this is reversed. This force is generally assumed to result from an imbalance of the frictional forces on the front and back of the tool. The material in front of the pin is colder than the material in the back of the tool, and thus the force to move the material at the same rate is higher in front of the tool than behind it.

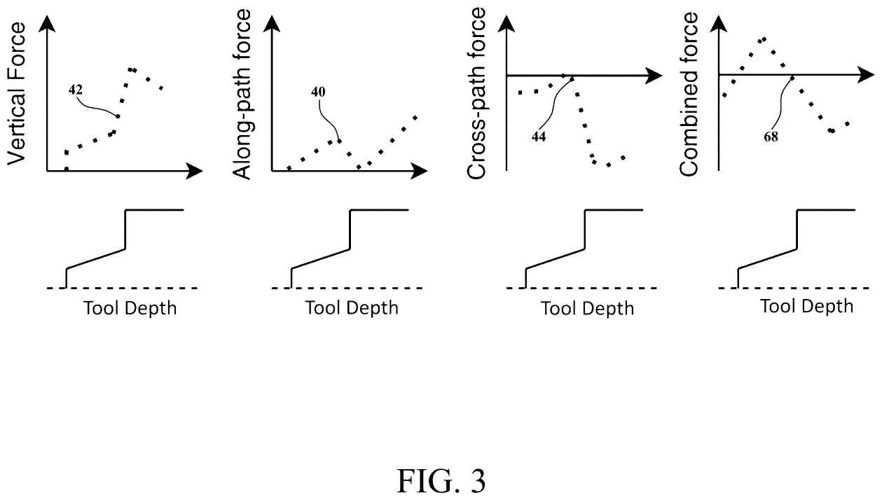

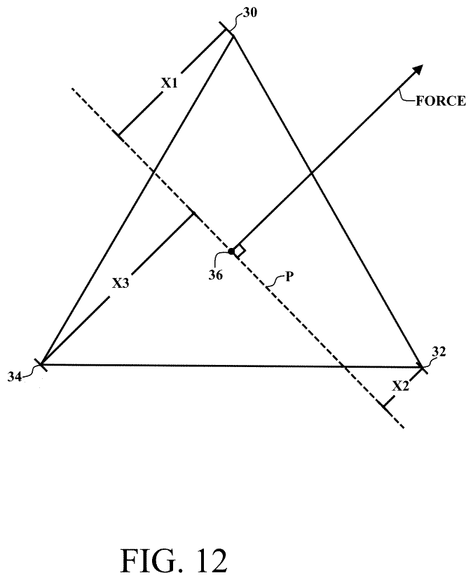

These forces 40, 42, 44 are measured by sensors in the weld head or related structure. The sensors 30, 32, 34, as shown in FIG. 1, are connected in a triangular arrangement around the rotational axis 36. In the embodiment shown herein, the sensors 30, 32, 34 are spaced at 120 degree intervals equally from the rotational axis 36, with each sensor 30, 32, 34 sensing tension or compression in a direction that is parallel to the rotational axis of the tool. However, it is contemplated that other force transducer arrangements are implemented to detect the forces 40, 42, 44. Force signals F1, F2, F3 from the sensors 30, 32, 34 are fed into the controller, where they are compared to each other and used to generate measured values for traverse force 40, forge force 42, and cross-seam force 44. Examples of these forces are shown in FIG. 3. For example, forge force 42 is calculated by combining the force signals from all three sensors. In the embodiment shown herein, the traverse force 40 and cross-seam force 44 are calculated by using the moment-arm of the elevation or vertical distance D between the tip of the tool and the force sensors 30, 32, 34, and the moment-arm of the sensor to the spindle axis in the direction of interest, based on the sensor's distance (in the same direction) from the spindle/rotational axis 36. The vertical distance D is shown in FIG. 1 with the term “vertical” used herein only for identification and without limitation to this disclosure in any way. First, the direction of the desired force is determined, and a perpendicular reference line P intersects the rotational axis 36, shown in FIG. 12. Because welding can follow a profile (instead of a straight line), the direction of the desired force can change during welding. However, traverse force remains in the direction of travel and cross-seam force remains perpendicular to the direction of travel. The distance X1, X2, X3 for each sensor 30, 32, 34 is measured from that reference line P to each sensor. The measurement is taken by the distance from the line parallel to the force. In the formula below, F1, F2, F3 is the force detected at each sensor and X1, X2, X3 is the corresponding distance from the reference line P to each sensor.

$$FORCE = \frac{F 1 * X 1 + F 2 * X 2 + F 3 * X 3}{D}$$

For example, if sensor 30 is aligned with the direction of interest, such as traverse force in the direction of travel shown in FIG. 1, the force F1 on sensor 30 multiplied by its distance R1 from the spindle axis 36 can be combined with the total force (F2+F3) on the other sensors 32, 34 multiplied by their distance X from the spindle axis with respect to the direction of travel. This will produce a resultant moment, which can be divided by the vertical distance D from the load cells to produce the traverse force. Represented as a simplified formula:

$$TRAVERSE FORCE = \frac{F 1 * R + ( F 2 + F 3 ) * X}{D}$$

The difference in force between sensors 32 and 34 can be used in a similar way to produce the cross-seam force. However, with the embodiment shown herein, the distance in the direction of interest for force sensor 30 is zero, so F1 is not part of the calculation. These are only example calculations using the sensor arrangement for this embodiment; the calculations would differ with other sensor arrangements or orientations.

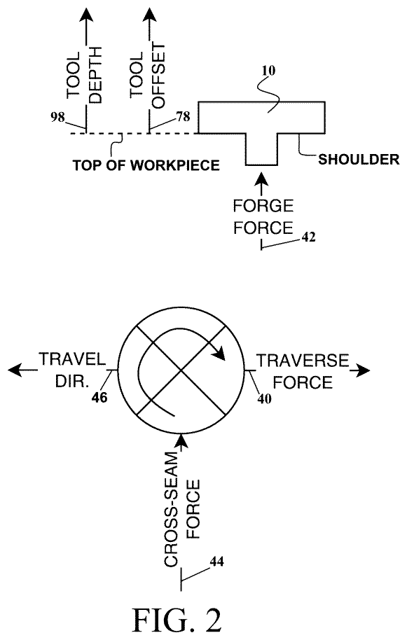

The tool is held by a spindle that is rotated by a motor which measures/controls speed and torque. Axial/forge force 42 is in the tool depth direction and is typically perpendicular to the top surface of the workpiece, and cross-seam force 44 is perpendicular to both traverse and axial force. This is shown in FIG. 1. During welding, the welding head or spindle 10 is rotating with a rotational speed and torque. When speed and torque are combined, power is calculated. FIG. 2 shows the welding head 10 from above, in one non-limiting example, with a clockwise rotation as the welding head moves to the left. The axial/forge force 42 is shown in FIG. 2. The traverse force 40 and cross-seam force 44 are perpendicular to each other. These forces 40, 44 form a plane that is parallel (or nearly parallel) to the top surface of the workpiece. These are only examples, and if the welding head 10 rotated oppositely from the direction shown in FIG. 2, the cross-seam force 44 would be in the opposite direction. The combination of the traverse 40 and inverted cross-seam 44 forces are also known as in-plane forces.

The rotational speed and torque are typically measured through the drive system (not shown) for the spindle. Temperature of the welding head 10 can be measured through an embedded thermocouple or other sensing means well-known in the art. Temperature can also be indirectly measured or calculated through other data that correlates with the softness of the material, such as spindle power, traverse force, or cross-seam force.

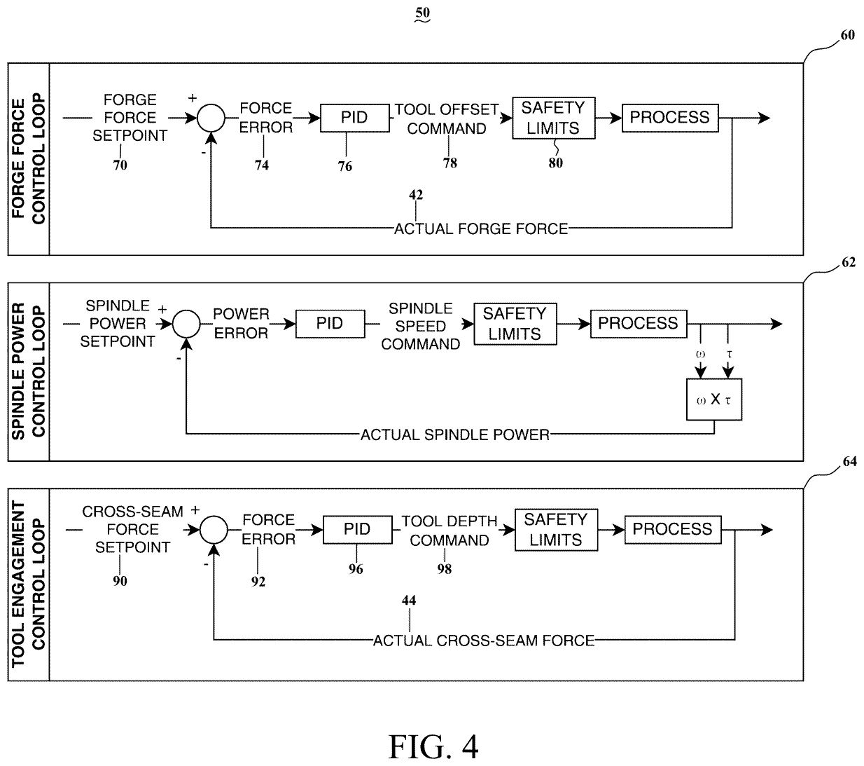

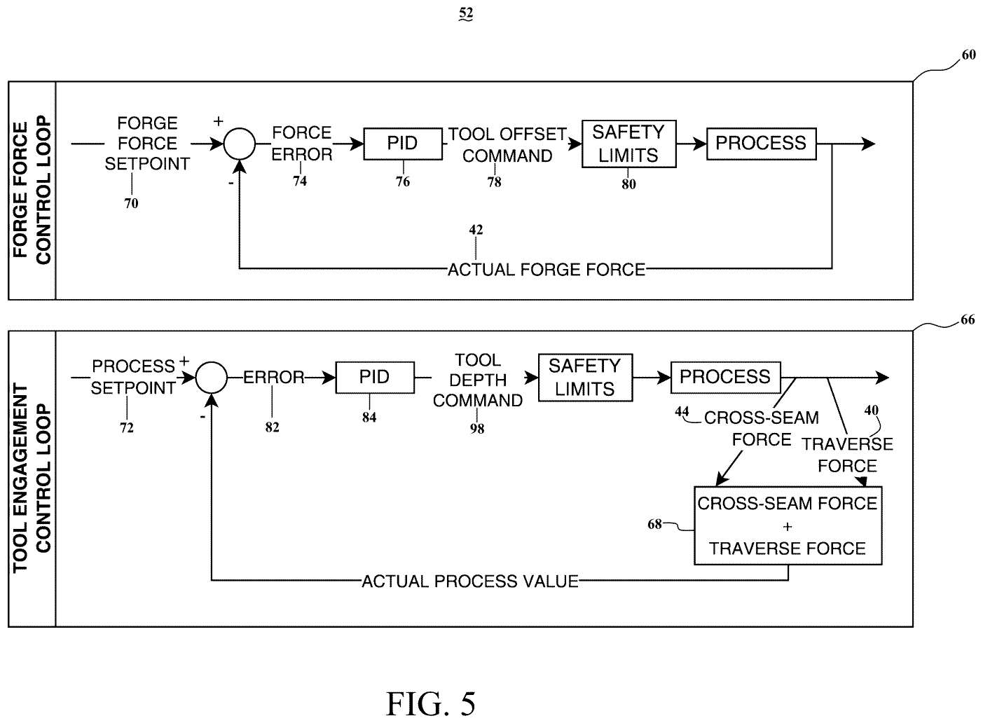

The invention consists of closed loop control of a friction stir welding process using one of the following control loops shown in FIGS. 4 and 5. The outputs of the closed loop control include spindle power (torque and/or speed), tool depth, and traverse speed. Inputs into the closed loop control include spindle power (torque and speed), tool depth, traverse force 40, forge force 42, and cross-seam force 44. These control loops include forge force control 60, two variations of tool engagement control 64, 66, and spindle power control 62. These control loops can be used with single sided (single weld head) or dual sided (opposing weld heads) welding. Dual sided welding is commonly used when material thickness dictates and/or when finished weld strength requirements demand it.

The two new control methods disclosed herein each utilize cross-seam force 44 in one way or another. The first method 50 is shown in FIG. 4 and the second method 52 is shown in FIG. 5. Some of the measurements and calculations are common between the methods 50, 52, and to the extent they are shared, they will be explained in the first method 50.

The first method 50 uses three independent but simultaneous control loops: axial/forge force control 60, spindle power control 62, and tool engagement control 64. Forge force control 60 is used to raise the tool (through the tool offset command) if forge force becomes excessive. A forge force setpoint 70 is determined from the material properties and geometry of the weld tool and workpiece. The measured forge force 42 is compared to the setpoint 70 to generate a force error 74. The force error 74 is fed into a proportional-integral-derivative (PID) loop 76 and a tool offset command 78 is calculated. The offset command 78 is compared to predetermined safety limits 80. This control method for forge force is different than the prior art forge force control in that the forge force control in the first method 50 is only treated as a safety limit feature. The setpoint for the tool depth/tool depth command is near or at the lower safety limit during normal operation such that if excessive forge force is detected, the adjustment of the tool offset command 78 causes the tool to raise out of the workpiece. Safety limit 80, especially the lower safety limit, is determined by the part thickness and the difference between pin length and part thickness. The first method 50 also includes a spindle power control loop 62, where spindle power is set and then measured. The spindle power control loop 62 is currently widely used in existing friction stir applications and will only be briefly described. With spindle power control 62, the weld input power is commonly set to a constant value. The spindle speed has a minimum and maximum limit used for safety boundaries. Because power=speed×torque, the controller adjusts one or both to achieve and maintain the desired power. The difference between the setpoint and measured power is used to adjust the commanded power of the spindle. Lastly, the first method 50 uses a tool engagement control 64. Tool engagement control 64 uses a cross-seam force setpoint 90 and measures the actual cross-seam force 44 to calculate a force error 92. The cross-seam force setpoint 90 is calculated based on the profile and geometry of the workpiece 20, such that if the part has curvature or predetermined high/low spots, the tool depth command 98 serves as the commanded depth as the welding head 10 follows the joint line 26. The force error 92 is fed into a PID loop 96 and is used to adjust the tool depth command 98 in real time. In the first method 50, traverse force is specifically excluded from all of the control loops 60, 62, 64 and not used for any part of the friction stir control. The first method 50 uses spindle power control 62 in combination with the tool engagement control loop 64 to regulate the temperature (material softness) and commanded depth of the spindle. The first method 50 is more robust to changing thermal boundaries, such as with long welds, double-sided welding, or welds that include irregular geometry. Because spindle power and temperature correlate, spindle power control 62 is implemented to maintain some level of temperature stabilization, which stabilized cross-seam enough to use just it as the depth control input. As previously discussed, Forge force control 60 is only used in the first method as a safety measure that intervenes only if excessive forge force 42 is detected. If dual-sided welding is used with the first method 50, each side has its own independent set of forge force control 60, spindle power control 62, and tool engagement control 64.

The final version of the first algorithm is, for both upper and lower spindles individually, as follows:
a. Axial/forge force control loop 60, set at a value where it only comes into effect if the forge force 42 rises way too high. Mostly side effect of the way the tool depth is being commanded, generally keeps the tool on the depth limit.
b. Power control loop 62, with the spindle power as the input and the drive torque as the output. Holds the weld input power to a constant setpoint value.
c. Tool engagement control loop 64, with the cross-seam force as the input and the tool depth limit as the output. Keeps the tool at a consistent engagement with the part.

The second method 52 uses the same forge force control loop 60 as in the first method 50 but uses an alternate tool engagement control loop 66. With the alternate tool engagement control loop 66, a process setpoint 72 is determined through experimentation. The cross-seam force 44 is measured, along with the traverse force 40. These measurements are combined to form an in-plane force 68 and then it is compared to the process setpoint 72 to generate an error signal 82 that is then fed into a PID loop 84. For clarity, the cross-seam force 44 and traverse force 40 are not used individually, only the result of the combination of these forces. The output of the PID loop 84 adjusts the tool depth command 98. The tool depth command 98 is compared to safety limits. The result of that comparison is used to adjust the tool depth. Broken down further, a high traverse force and high cross-seam force result in a high in-plane force 68. For the purposes of this disclosure, a high force means more positive. For example, if the setpoint was 200N, a traverse force of 600N and a cross-seam force of-400N would equate to an in-plane force of 200N. A high in-plane force 68 would result in the tool depth being increased. In the second method 52, spindle power is excluded from the control loops 60, 66. In the second method 52, cross-seam force and traverse force cancel out the effects of the material softness in the workpiece 20.

The final version of the second algorithm is:
a. Axial/forge force control loop 60, set at a value where it only comes into effect if the tool force rises way too high. Mostly side effect of the way the tool depth is being commanded, generally keeps the tool on the depth limit.
b. Tool engagement control loop 66 with cross-seam force and traverse force combined as the input and the tool depth limit as the output.

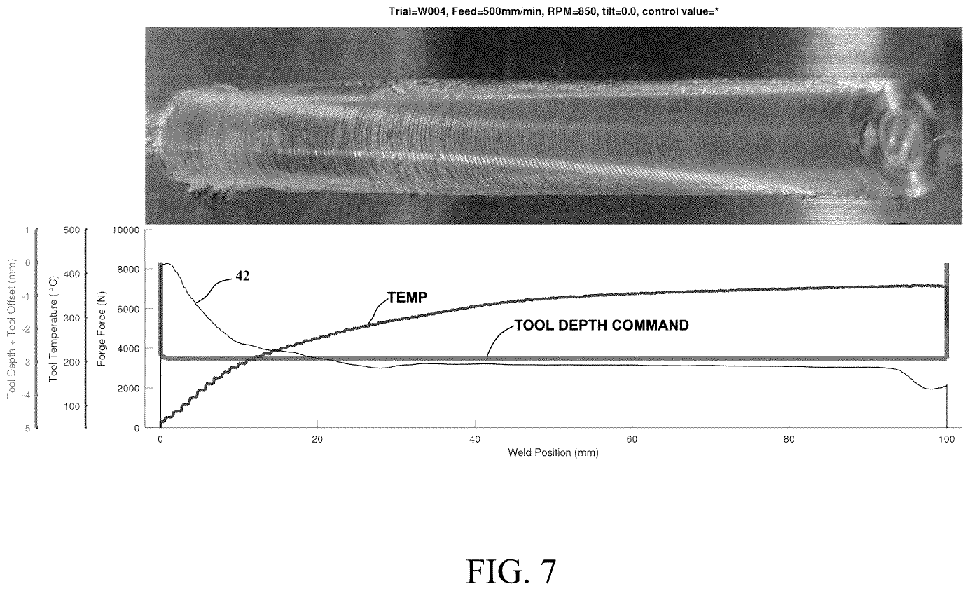

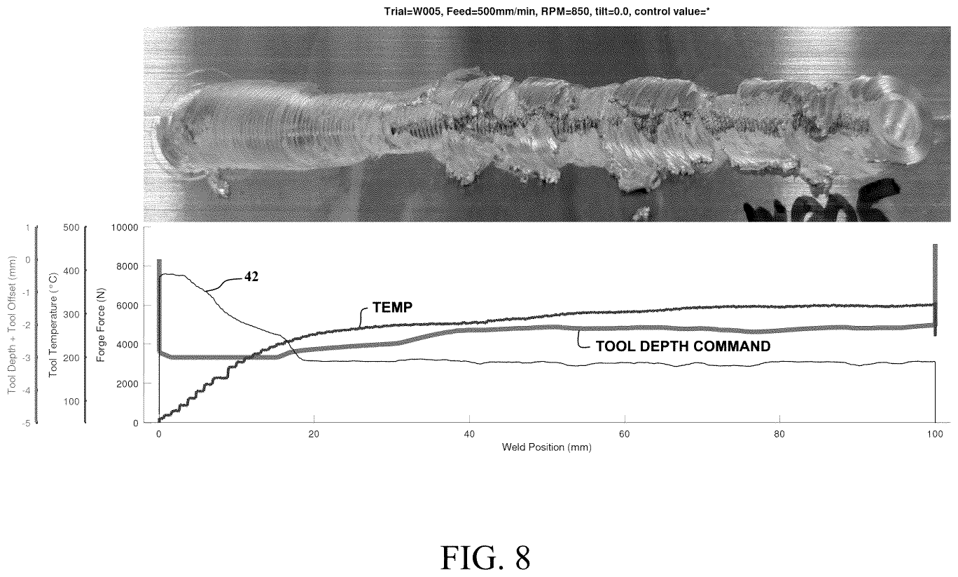

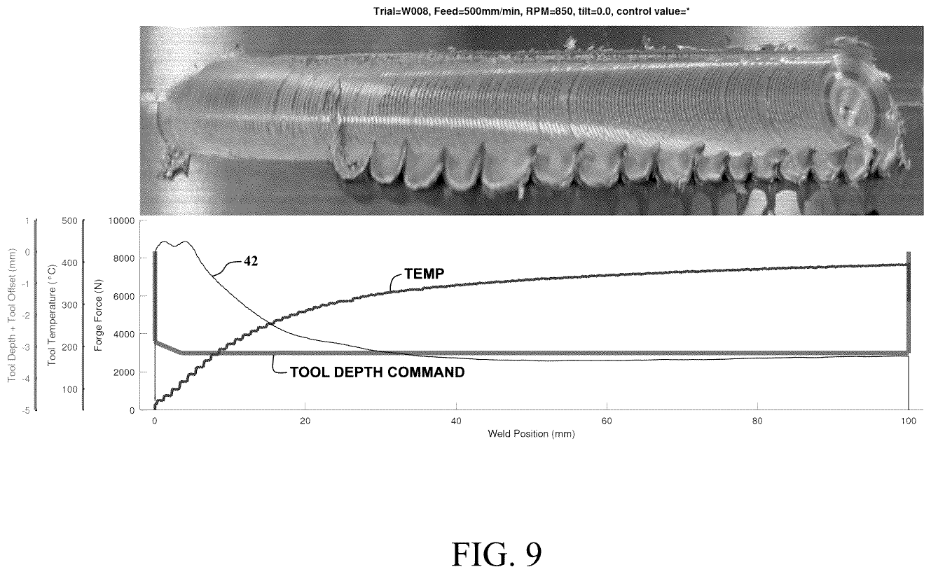

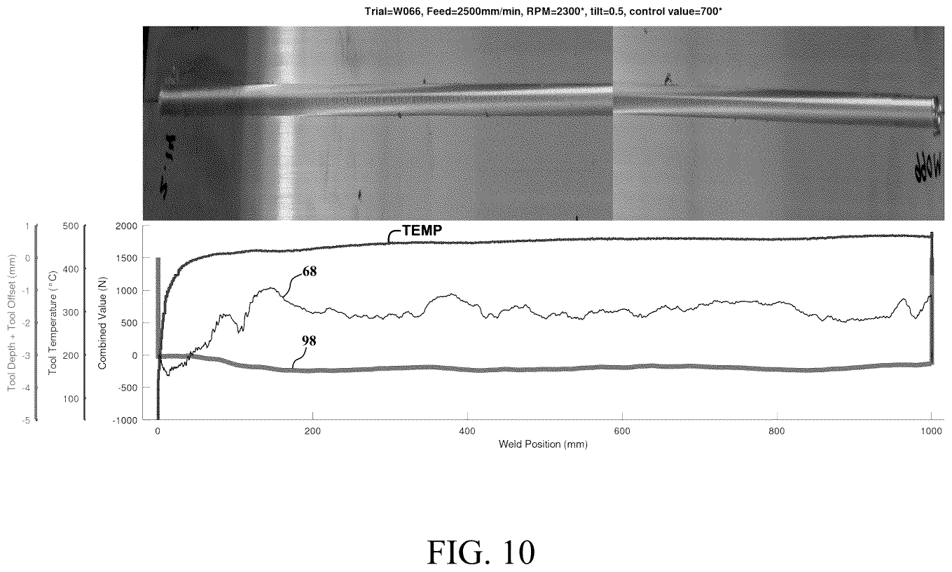

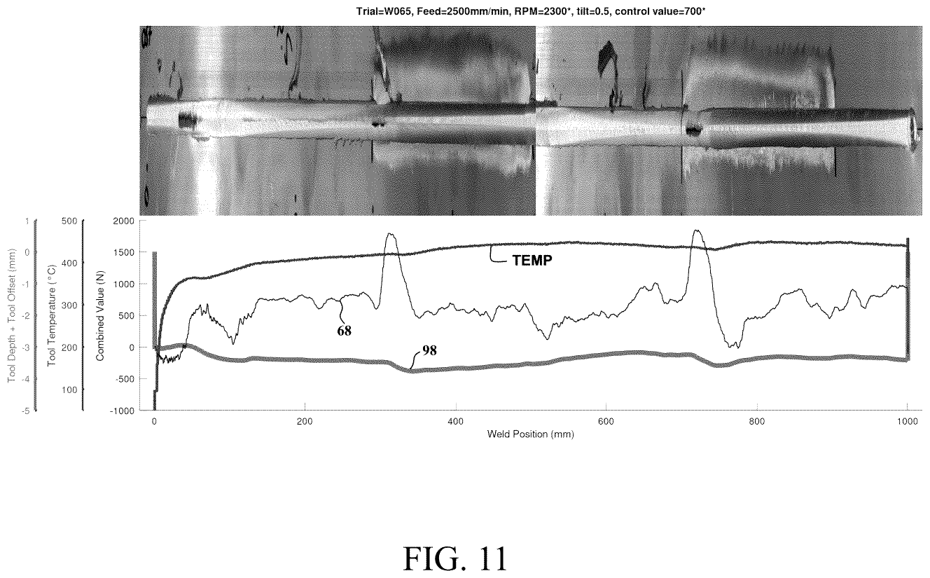

Testing results using the second method 52 show the control loops' ability to compensate for workpiece irregularity or deflection and/or machine deflection. In FIGS. 7-11, an image of a weld is scaled and aligned with a graph displaying data taken during that weld. FIGS. 7, 8, and 9 show testing results using standard process controls, without the implementation of either method 50, 52. FIG. 7 shows a normal weld, FIG. 8 shows a weld that had inadequate tool engagement, and FIG. 9 shows excessive tool engagement. Further testing and analysis revealed that cross-seam force, traverse force, and torque all seemed to be related to the tool engagement. By combining traverse (the direction of the welding path) and cross-seam forces in the second method 52, the signal became more linear. There was a small effect of tool temperature on all the forces, but with traverse and cross-seam combined, it was small enough to not affect the welding. FIG. 10 is a 1 meter long weld using the second method 52 and FIG. 11 shows the second method 52 controlling the tool depth on a workpiece with an irregular surface. FIG. 11 shows a weld with alternating high and low regions to determine how stable the algorithm was to disturbances. The test piece used for FIG. 11 was machined with step changes in the top surface to create disturbances. While it appears not fully tuned for response time, it did respond properly, indicating a stable algorithm.

For parts that are more complex, have varying heat-sinking rates in the weld area, or where the weld passes by itself again, the first method 50 is more appropriate. In contrast, the second method 52 is more appropriate for single extrusion welds, welds when the heat-sinking rate is consistent along the weld, or for welds with more consistent thermal boundaries. Unlike the first method 50, the second method 52 does not require power control.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method performed by a controller of maintaining optimum engagement depth of a friction stir welding tool without measuring traverse force, said method comprising:
providing a spindle for rotating said friction stir welding tool and moving in a direction of travel, said spindle capable of sensing depth force and cross-seam force, said cross-seam force being perpendicular to said direction of travel, said spindle rotating said friction stir welding tool about a rotational axis, said spindle having power sensing for rotational torque and speed;
rotating said friction stir welding tool and moving said friction stir welding tool in said direction of travel;
measuring said depth force, said cross-seam force, and said rotational torque and speed;
providing a spindle power control loop comprising the following steps:
combining said rotational torque and speed to generate a power value;
providing a spindle power setpoint;
comparing said spindle power setpoint to said power value to generate a power error value;
adjusting said rotational torque or speed in response to said power error value;
providing a tool engagement control loop comprising the following steps:
providing a cross-seam setpoint;
comparing said cross-seam force to said cross-seam setpoint to generate a cross-seam error value; and
adjusting a depth of said spindle in response to said cross-seam error value;
providing a forge force control loop comprising the following steps:
comparing a force setpoint to said depth force to generate a depth error value;
reducing said depth of said spindle only if said depth error value exceeds a depth error limit; and
independently operating said spindle power control loop, said tool engagement control loop, and said forge force control loop.

2. The method of claim 1, further providing a first, second, and third force transducer affixed to said spindle, each said force transducers having a corresponding first force signal F1, second force signal F2, and third force signal F3, said force transducers spaced from each other and said rotational axis, said force transducers spaced from said friction stir welding tool by a distance D, selecting a direction for a desired force F extending perpendicularly from said rotational axis, setting a reference line extending through and perpendicular to said rotational axis and said force direction, measuring a first distance X1 from said reference line to said first force transducer, measuring a second distance X2 from said reference line to said second force transducer, measuring a third distance X3 from said reference line to said third force transducer, calculating said desired force F at said friction stir welding tool according to the following formula:
$$F = \frac{F 1 * X 1 + F 2 * X 2 + F 3 * X 3}{D}$$

3. The method of claim 2, wherein said desired force is said cross-seam force.

4. The method of claim 1, further providing a proportional-integral-derivative (PID) in one of said control loops, providing a corresponding said error value to said PID.

5. The method of claim 1, further providing a first, second, and third force transducer affixed to said spindle, each said force transducers having a corresponding first force signal F1, second force signal F2, and third force signal F3, calculating said depth force by adding said first, second, and third force signals.

6. The method of claim 1, wherein said tool engagement control loop increases said depth of said spindle when said cross-seam force is higher than said cross-seam error value.

7. A method performed by a controller of deflection compensation and maintaining optimum engagement depth of a friction stir welding tool moving in a direction of travel, said method comprising:
providing a spindle for rotating said friction stir welding tool and moving in said direction of travel, said spindle capable of sensing depth force, traverse force, and cross-seam force, said traverse force in said direction of travel and said cross-seam force perpendicular to said direction of travel, said spindle rotatable about a rotational axis;
measuring said depth force, said traverse force, and said cross-seam force;
providing a tool engagement control loop comprising the following steps:
providing a process setpoint;
combining said traverse and said cross-seam forces to calculate an in-plane force;
comparing said process setpoint to said in-plane force to generate an error value;
adjusting a depth of said spindle in response to said error value; and
providing a forge force control loop comprising the following steps:
comparing a force setpoint to said depth force to generate a depth force error value;
reducing said depth of said spindle only if said depth force error value exceeds a second error limit; and
independently operating said tool engagement and forge force control loops.

8. The method of claim 7, further providing a first, second, and third force transducer affixed to said spindle, each said force transducers having a corresponding first force signal F1, second force signal F2, and third force signal F3, said force transducers spaced from each other and said rotational axis, said force transducers spaced from said friction stir welding tool by a distance D, selecting a direction for a desired force F extending perpendicularly from said rotational axis, setting a reference line extending through and perpendicular to said rotational axis and said force direction, measuring a first distance X1 from said reference line to said first force transducer, measuring a second distance X2 from said reference line to said second force transducer, measuring a third distance X3 from said reference line to said third force transducer, calculating said desired force F at said friction stir welding tool according to the following formula:
$$F = \frac{F 1 * X 1 + F 2 * X 2 + F 3 * X 3}{D}$$

9. The method of claim 8, wherein said desired force is said cross-seam force.

10. The method of claim 8, wherein said desired force is said traverse force.

11. The method of claim 7, further providing a first, second, and third force transducer affixed to said spindle, each said force transducers having a corresponding first force signal, second force signal, and third force signal, calculating said depth force by adding said first, second, and third force signals.

12. The method of claim 7, further providing a first, second, and third force transducer affixed to said spindle, each said force transducers having a corresponding first force signal, second force signal, and third force signal, when said direction of travel is aligned with one of said force transducers, one of said traverse force or said cross-seam force is calculated by comparing said first force signal to said second and third force signals.

13. The method of claim 12, wherein the other of said cross-seam force or said traverse force is calculated by comparing said second and said third force signals.

14. A method of maintaining optimum engagement depth of a friction stir welding tool performed by a controller, said method comprising:
providing a spindle for rotating said friction stir welding tool and moving in a direction of travel, said spindle capable of sensing depth force, traverse force, and cross-seam force, said traverse force in said direction of travel and cross-seam force perpendicular to said direction of travel, said spindle rotating said friction stir welding tool about a rotational axis, said spindle having power sensing for rotational torque and speed;
rotating said friction stir welding tool and moving said friction stir welding tool in said direction of travel;
measuring said depth force, said traverse force, said cross-seam force, and said rotational torque and speed;
providing a tool engagement control loop comprising the following steps:
providing a process setpoint;
comparing said cross-seam force to said process setpoint to generate a cross-seam error value; and
adjusting a depth of said spindle in response to said cross-seam error value;
providing a forge force control loop comprising the following steps:
comparing a force setpoint to said depth force to generate a depth error value;
reducing said depth of said spindle only if said depth error value exceeds a depth error limit; and
independently operating said tool engagement and forge force control loops.

15. The method of claim 14, further providing a spindle power control loop comprising the following steps: combining said rotational torque and speed to generate a power value, providing a spindle power setpoint, comparing said spindle power setpoint to said power value to generate a power error value, adjusting said rotational torque or speed in response to said power error value.

16. The method of claim 14, wherein said tool engagement control loop further provides adding said traverse force to said cross-seam force to calculate an in-plane force, comparing said in-plane force to said process setpoint to generate said cross-seam error value.

17. The method of claim 14, further providing a first, second, and third force transducer affixed to said spindle, each said force transducers having a corresponding first force signal F1, second force signal F2, and third force signal F3, said force transducers spaced from each other and said rotational axis, said force transducers spaced from said friction stir welding tool by a distance D, selecting a direction for a desired force F extending perpendicularly from said rotational axis, setting a reference line extending through and perpendicular to said rotational axis and said force direction, measuring a first distance X1 from said reference line to said first force transducer, measuring a second distance X2 from said reference line to said second force transducer, measuring a third distance X3 from said reference line to said third force transducer, calculating said desired force F at said friction stir welding tool according to the following formula:
$$F = \frac{F 1 * X 1 + F 2 * X 2 + F 3 * X 3}{D}$$

18. The method of claim 17, wherein said desired force is said cross-seam force.

19. The method of claim 17, wherein said tool engagement control loop further provides adding said traverse force to said cross-seam force to calculate an in-plane force, comparing said in-plane force to said process setpoint to generate said cross-seam error value, said desired force is said traverse force.
